(19) United States
(12) Patent Application Publication
(10) Pub. No.: US 2002/0161632 A1
(43) Pub. Date: Oct. 31, 2002

(54) Method to attract consumers to a sales agent

(76) Inventors: David Hagen, Southern Pines, NC (US); Thomas J. O'Hanlon, Whispering Pines, NC (US)

Correspondence Address: COATS & BENNETT, PLLC, P O BOX 5, RALEIGH, NC, 27602, US

(21) Appl. No.: 09/842,997

(22) Filed: Apr. 26, 2001

(51) Int. Cl. G06F 17/60

(52) U.S. Cl. 705/14; 705/10

(57) ABSTRACT

A method of promoting sales for goods and/or services comprises providing a potential consumer a software program that enables the potential consumer to play a game. To collect the prize of the game, the potential consumer may contact a remote sales agent, subjecting the potential consumer to a sales presentation.

### RELATED APPLICATIONS

Copending U.S. patent applications Ser. Nos. 09/614,399; 09/680,796, and 09/750,954 filed Jul. 12, 2000; Oct. 6, 2000; and Dec. 28, 2000 respectively are related to the present invention and are herein incorporated by reference in their entireties.

### BACKGROUND OF THE INVENTION

1. Field of the Invention

The present invention relates to an incentive based method to attract potential consumers to a sales agent for presentation of a sales pitch for a good or service.

2. Description of the Related Art

Internet commerce has exploded into the public awareness. The 1990s and first part of 2000 saw a flurry of activity in the industry as the “dot coms” advertised in such diverse locations as the Super Bowl, on the sides of buses, at trade shows, and the like. The initial burst of energy and investment focused on the Business to Consumer model.

These days, market evolutionary forces are winnowing out companies with poorly designed web pages. Other companies that do have a viable good or service and have a viable business model are also struggling to secure new customers. Some statistics show that an online broker spends as much as three hundred dollars to attract a new account. This is an incredibly daunting figure for a new company to spend for each new customer.

At the same time, it is becoming increasingly hard to get new customers to new sites. People are becoming sedentary in their online shopping, only going to a few established Internet commerce providers. This may be in spite of the fact that other sites have better prices, better service, and/or better products.

Thus, there remains a need for a method to attract people to interface with a business on a personal level so as to promote the creation of a new customer account and/or sale to the new customer.

### SUMMARY OF THE INVENTION

The present invention comprises distributing computer readable media to a plurality of potential consumers. Upon installation of a computer readable medium into the potential consumers' computers, a software program stored on the medium reviews the hardware configuration of the potential consumer. Depending on the hardware available, and specifically on the presence or absence of a network connection, the software program may launch a game locally or take the potential consumer to a URL where the potential consumer may play a game.

The game may award the potential consumer a prize related to a business that is seeking to attract new consumers. To collect the prize, the potential consumer is connected to a sales agent who may then make a sales presentation to the potential consumer personally.

In one embodiment, where there is no network connection on the computer, the potential consumer may telephone the sales agent. In another embodiment, where there is a network connection, the potential consumer is taken to a web site at which the sales agent and the potential consumer may begin a dialogue. The dialogue format depends on the nature of the hardware available at the potential consumer's computer. The format may be a text based chat session, a voice over Internet session, or a full duplex video conference, or other format, as needed or desired.

### BRIEF DESCRIPTION OF THE DRAWINGS

FIG. 1 illustrates a front plan view of a computer such as may be used by a potential consumer using the present invention;

FIG. 2 illustrates a schematic diagram of one embodiment of a network via which the potential consumer may be connected to a remote sales agent;

FIG. 3 is a flow chart illustrating exemplary preliminary steps taken by a business to utilize the present invention; and

FIGS. 4A & 4B are a flow chart illustrating exemplary steps taken by the potential consumer and software of the present invention separated due to space constraints.

### DETAILED DESCRIPTION OF THE INVENTION

The present invention comprises a method to attract potential consumers in hopes that they will consummate a sale with a business. A potential consumer, as that term is used herein, may be anyone capable of entering into a legal contract. A business, as that term is used herein, may be a corporation, a partnership, a sole proprietorship, or other real or legal entity that conducts a legal business. The following businesses are particularly contemplated as being well suited for using the present invention: pornographers, electronic product sales, psychic hotlines, online trading companies, and telemarketers for various goods and services.

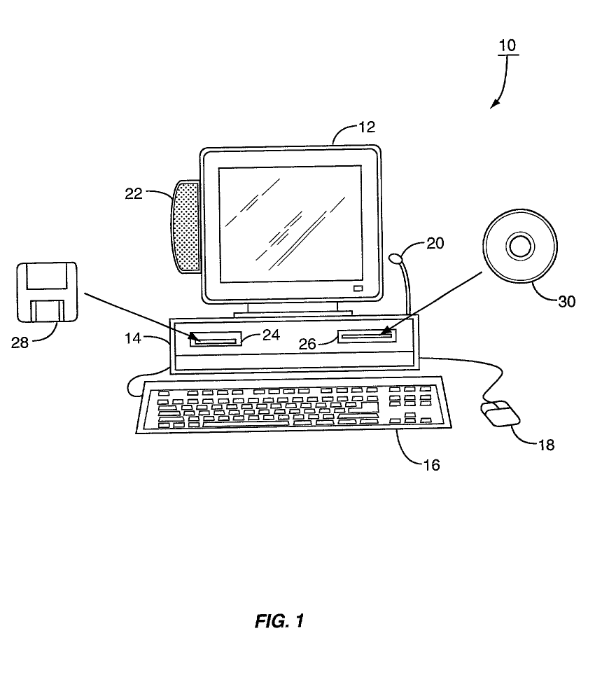

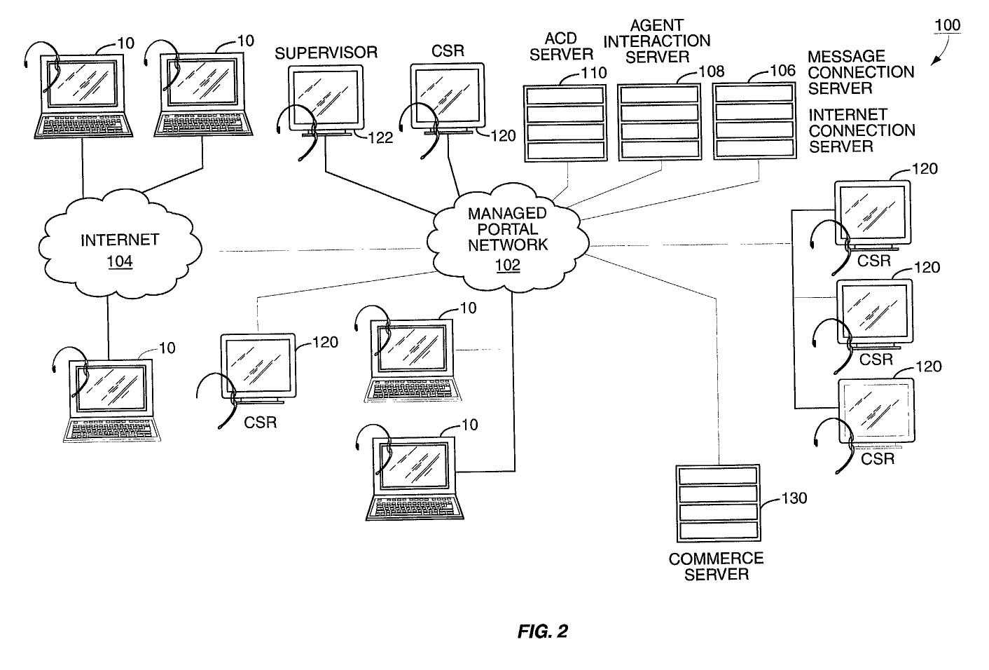

The present invention assumes that the business has the means to handle incoming phone calls and communications in an appropriate manner. Particularly contemplated are the call centers described in the previously incorporated related applications. The entity that runs the call center is sometimes referred to herein as the service provider. These call centers enable sales agents to handle incoming bi-directional video calls as well as push content down transmission paths to potential consumers. Content and communication may be text based, such as by an instant messenger program, voice over Internet, or full video streaming as needed or desired. The interested readers are referred to the previously incorporated applications for a full explanation of these features. However, a brief overview of some of the hardware is presented with reference to FIGS. 1 and 2.

To effectuate the present method, it is advantageous for the potential consumer to have some sort of data processing device such as a computer 10, illustrated in FIG. 1. It is expected that the methodology of the present invention will be implemented at least in part by software that will run, in part, on the computer 10. Computer 10 may comprise a display 12, a desk unit 14 housing a motherboard and microcontroller such as an INTEL PENTIUM IV or the like, a keyboard 16, a mouse 18, a microphone 20, a speaker 22, and other paraphernalia as is well understood. Further, the desk unit 14 may comprise a floppy disc drive 24 and a CD-drive 26 capable of receiving computer readable media such as a disk 28 and a CD 30 respectively. The relevant portions of the software of the present invention may be stored on the computer readable media 28, 30 as needed or desired.

A plurality of computers 10 operate within a communication system 100 as illustrated in FIG. 2. In particular, computers 10 may be part of a managed portal network 102 operated by a service provider operating according to the present invention, although this need not be true. Managed portal network 102 interfaces with the Internet 104 and particularly with the World Wide Web (www). It is more likely, however, that the computers 10 are not part of the managed portal network 102, and merely connected to the Internet 104 such as through an Internet Service Provider (ISP) such as Time Warner's Roadrunner service, aol.com, Bellsouth.net, or the like. A call center is also associated with the managed portal network 102. This call center may be comparable to that disclosed in the above identified related applications. Alternatively, the call center may be comparable to that disclosed in U.S. Pat. No. 6,046,762, the entire disclosure of which is hereby incorporated by reference. A brief overview of an appropriate system is herein provided to avoid the need to read those references. However, the interested reader is encouraged to read the references for a complete and full understanding of the call center. A message connection server 106, which may double as an Internet connection server, an agent interaction server 108, and an ACD server 110 may also form part of the managed portal network 102. Further, aplurality of customer service representative (CSR) stations 120 and supervisor stations 122 may be included within the managed portal network 102. Still further, a commerce server 130 may be part of the managed portal network 102. It should be appreciated that the communicative links between elements of the managed portal network 102 are high bandwidth, high speed connections such as T1 lines, E1 lines, broadband wireless links, two-way satellite communication, cable lines, fiber optic lines, or the like. However, data compression technology allows normal phone lines or twisted pair lines to be used if required.

Servers 106, 108, and 110 act to route messages from computers 10 to CSR stations 120 and to the commerce server 130 as needed. CSR stations 120 comprise a camera (not shown explicitly), at least one monitor, a headset having a microphone and speaker capabilities, and other communicative capabilities. Each CSR station 120 is staffed by a trained sales agent having one or more specialty areas. As calls come in to the server 106, the server 106 routes the call to the appropriate CSR station 120. The accessed CSR station 120 may then begin bi-directional, interactive communication with the computer 10. This interactive communication may take the form of a video phone call, content being pushed down the communicative link, or other form as needed or desired and as explained fully in the above incorporated co -pending applications. The term call, as used herein, specifically includes accessing a web page, making a phone call, or the like.

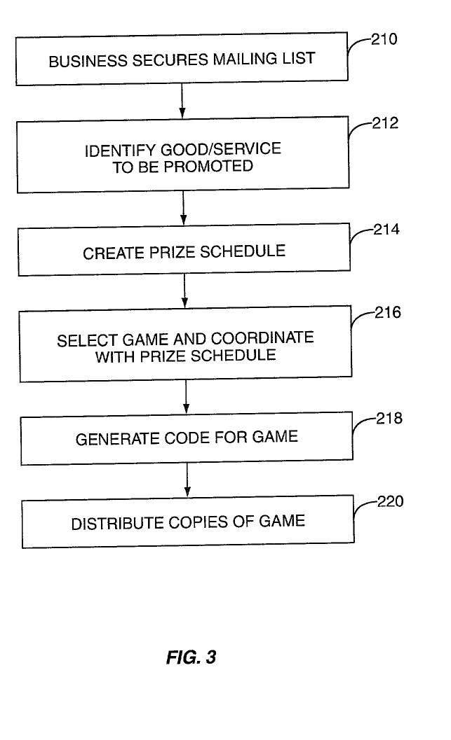

There are several ways that the present invention may be practiced. An exemplary technique is herein presented. Referring to FIG. 3, a flow chart illustrates some preliminary steps that a business may undertake to practice the present invention more effectively. In particular, the business secures some form of mailing list of potential consumers (block 210). This mailing list may be purchased from another entity such as a telephone company, a credit card company, or the like as needed or desired. This mailing list may alternatively be self-generated by employees or independent contractors as needed or desired. Still other techniques of securing mailing lists are well understood in the art. This mailing list may include a potential consumer's residence or postal address, a telephone number associated with the potential consumer, an email address, and other information as needed or desired. Note that not all the information listed need be present in the mailing list, but the list at a minimum should have enough information about a potential consumer through which to contact the potential consumer by some medium.

The business then identifies a good and/or service to be promoted by the present invention (block 212). The range of available goods and/or services that may be effectively promoted with the present invention is essentially limitless, although the present invention is particularly well suited for reasonably sophisticated goods and/or services such as home electronics, Internet trading services, and the like. The mailing list may be screened for certain demographics if that information is available based on the good and/or service promoted. For example, individuals below a certain income threshold may be excluded as unlikely to be able to afford a particular good and/or service. As another example, individuals in a certain postal area may not be able to receive satellite television service as a result of nearby geographical features, and thus they may be excluded from a promotion for satellite television. Other thresholds or filters will be readily apparent to those designing the promotions, as the business presumably knows a target audience for its good/service.

The business may then create a prize schedule to go with the promotion (block 214). The prize schedule may ensure a minimum participatory prize with multiple levels of awards above that. For example, in a promotion to sell satellite television sets and service, the business may decide that everyone who participates may receive a free installation. Some percentage of participants will receive a free satellite dish and installation. Some other, smaller percentage of participants will receive a small cash prize. Finally, a very small percentage of participants in the promotion will receive a large cash prize.

The business may select a game and coordinate the game with the prize schedule (block 216). For example, a slot machine type game may be selected and the prizes assigned to permutations on the results of the slot wheels. In this way, odds may be created that the correct percentages will be awarded the desired number of prizes. Other games and prize schedules are also contemplated.

The business may generate the code for the game (block 218). This may be as simple as adapting an existing game for use with the prize schedule or writing the code from scratch, but the end result is the creation of software to run the game. The software may be imprinted on computer readable media such as compact discs, diskettes, memory sticks, smart cards, or the like as needed or desired. The code may be in any suitable programming language such as C++, visual basic, or the like.

The business may then distribute copies of the game (block 220). In a first embodiment, the distribution is through the mail system. The distribution may be accompanied by the appropriate disclaimers that no purchase is necessary to play, void where prohibited, and the like to comply with the appropriate gaming laws of the jurisdictions in which the game will be played.

In a second embodiment, the distribution is not a distribution of tangible computer readable media, but rather an electronic distribution, such as by email, or delivered wirelessly to a mobile terminal such as a mobile phone, personal digital assistant, or the like. Thus, mailing lists that include phone addresses or email addresses are also useful to the business. In this embodiment, having acquired the potential consumer's email account, the service provider may generate low cost, mass email. While indiscriminately sent email is not always appreciated by the recipients, it is possible that the service provider may target the recipients to those who have indicated a willingness to receive promotional offers or the like. The software may be sent as an attachment to the email, or in the body of the email. Attachments such as .docs, .mp3s, .jpgs, and the like are well understood and most conventional mail servers have the ability to attach and decipher files. In this particular case, th e attachment may be an executable file, and thus may be rigorously vetted against viruses and the like to instill consumer confidence.

As still another embodiment, the computer readable media may be passed out at a high traffic location, such as a kiosk in a mall, on an airport concourse, or other place as needed or desired. It should be appreciated that in this embodiment, it is not necessary to secure a mailing list.

It should be appreciated that the computer readable media may be packaged in eye catching, motivational materials so that potential consumers are encouraged to install the software on their computer 10 from the computer readable media.

Note that the precise order of the steps in FIG. 3 may be rearranged as needed by the business. For example, the game design and prize schedule need not occur after securing the mailing list.

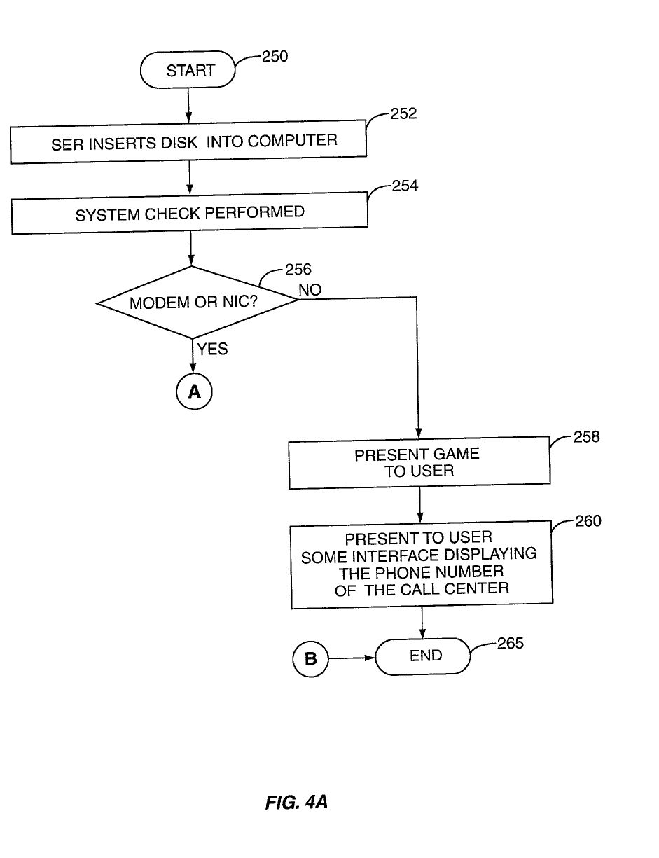

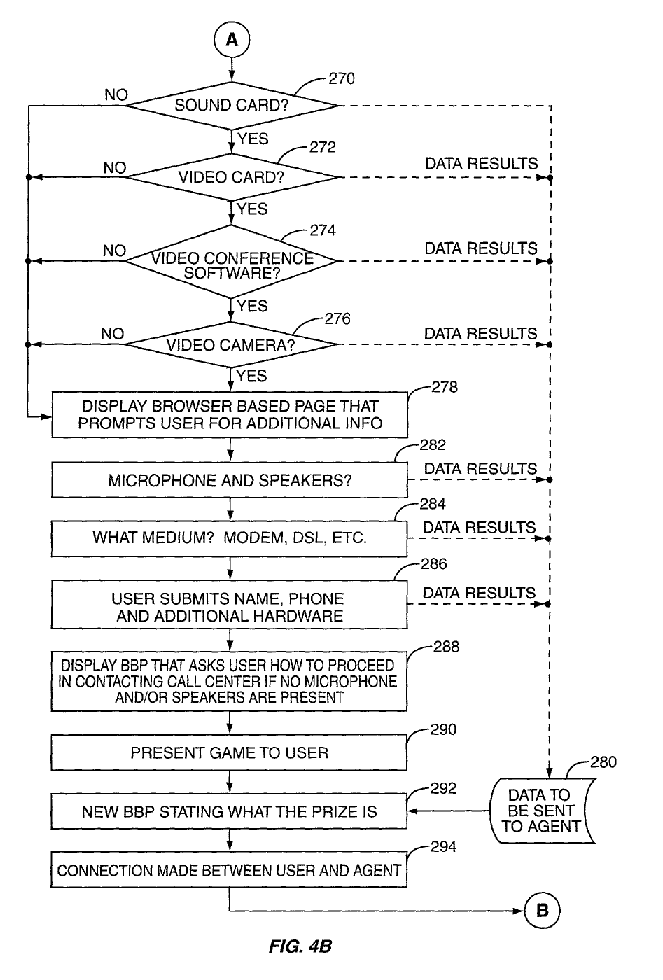

Taking the embodiment where the potential consumer receives a tangible computer readable medium, the next steps in the process are illustrated in FIGS. 4A & 4B. This is the same flow chart, however, it has been broken apart for clarity. The process starts at block 250 and the potential consumer (labeled user in FIGS. 4A & 4B) inserts the medium into the computer 10 (block 252). Depending on the nature of the media, this may be the floppy drive 24 or the CD drive 26. The software on the medium performs a system check of the computer 10 into which it has been inserted (block 254). This may be done during an installation process or otherwise hidden from the potential consumer's awareness if needed or desired.

The system check determines several things, but initially determines if there is a modem or other network interface card (NIC) present in the computer 10 (block 256). If the answer to block 256 is negative, the software immediately presents the game to the potential consumer (block 258). In an exemplary embodiment, the game is a slot machine game run on the potential consumer's computer 10. The game runs and the potential consumer is awarded a prize determined by the prize schedule. The potential consumer is presented some interface displaying a phone number and/or other contact information of a sales agent or the like (block 260). The interface may further explicate that the prize is only redeemable if the potential consumer contacts the sales agent. The process ends (block 265). This is for situations in which the potential consumer does not have a modem or other outside Internet access mechanism installed in his comp uter 10. The potential consumer would call a sales agent in the call center previously described and collect the prize while being exposed to a sales presentation.

If the answer to block 256 is yes, there is a modem or NIC, then the system check continues (see FIG. 4B). Note that the system check may check for cable modems, DSL modems, a T1 connection, other conventional modems, Ethernet connections, or the like as needed or desired. The modem may also be wireless if needed or desired, but the purpose of the test is to determine if the potential consumer has access to the Internet 104 for the purposes explained below.

The next test the system check runs is to determine if the computer 10 has a sound card (block 270). If the answer is yes, the system check determines if there is a video card (block 272). If the answer is yes, the system check determines if there is video conferencing software such as MICROSOFT NETMEETING™ (block 274). Finally, the system check determines if there is a video camera installed on the computer 10 (block 276).

Having made the appropriate determinations, the software then connects to the Internet 104. This may launch a web browser such as NETSCAPE NAVIGATOR™, MICROSOFT INTERNET EXPLORER™, or other browser as needed or desired. Further, if the potential consumer does not have a normal Internet Service Provider (ISP), the software may summon a routine that calls a toll free number for an ISP belonging to the business. Other techniques of securing an Internet connection will be readily apparent to those skilled in the art. Once the Internet connection is secured, the software takes the browser to a web page that prompts the user for additional information (block 278).

If at any time in the system check steps 270-276 the answer is no, the system check skips to block 278. This order may be changed, but by placing steps 270-276 in this order, processing steps are minimized if a negative result is returned. This is because it will not matter if there is a video card if there is no sound card, and similarly, it will not matter if there is video conferencing software if there is no sound card or no video card. The system check also outputs the results of each check (noted data results in FIG. 4B) that is sent to the sales agent (block 280).

The additional information that the web page in block 278 asks for may include whether the potential consumer has a microphone 20 and speakers 22 on their computer 10 (block 282). It may further ask what sort of connection the potential consumer has with the Internet 104 (block 284). The potential consumer may answer with a baud rate, (56.6, 48.8, etc.) DSL modem, cable modem, T1, or the like. The potential consumer is also prompted for a name, a phone number, and any other additional hardware that may be of interest (block 286). Note that the prompts for the information may be in conventional data field entry screens, by check boxes, radio buttons, or the like as needed or desired. The data results of blocks 282-286 are also sent to the sales agent (block 280).

After determination of the hardware, both from the system check and the potential consumer's input, the software may query the potential consumer as to how they wish to proceed if there is not a microphone 20 and/or speakers 22 present (block 288). This may be done in a new web page as needed or desired. The game is presented to the potential consumer (block 290). The potential consumer plays the game and is alerted to the existence of the prize that they have won (block 292).

The potential consumer is then connected to a sales agent in the call center (block 294) and the sales agent is given the opportunity to solicit and consummate a sale with the potential consumer. This opportunity to make such a sales presentation may comprise the sales agent using the tools of the call center to present a full bi-directional video communication with the potential consumer as explicated in the previously incorporated applications. Alternatively, if the potential consumer does not have the tools for such a video conference, or the bandwidth connection to support a lot of video streaming supplemental information (or other reason), the sales agent may proceed with a voice over Internet communication, a text based message connection such as an instant messenger program, or other communication technique as needed or desired. The process then ends (block 265).

In another embodiment, a virtual sales agent may be presented to the potential consumer. Rather than have a video feed from the sales agent, a “talking head” such as those created by LIPSinc of Research Triangle Park, North Carolina may be used. Further information about such virtual personalities may be found at www.lipsinc.com. The virtual agent may be controlled by the sales agent as needed or desired.

Note that the connection to the Internet 104 may occur after the game is played if needed or desired. Thus, the game, system check, and consumer inputs as to hardware configurations may all be based on the software present on the computer readable medium. Other rearrangements in the precise order of the events in FIGS. 4A & 4B are also contemplated. For example, the potential consumer input as to the existence of speakers 22 and a microphone 20 may occur after the game is played. Such variations are well within the scope of the present invention.

In an alternate embodiment, the software is not stored on a computer readable medium, but rather may be delivered to the computer 10 through some other technique such as email, wireless transmission or the like. As yet another variant, the software may be a JAVA applet and act like a pop up window when the potential consumer performs a predetermined action while surfing the web. For example, leaving a certain site may trigger a pop up window that runs the software of the present invention and gives the potential consumer the opportunity to play the game and ultimately be subjected to the sales presentation of the sales agent.

As still another embodiment, it is possible to install the software on computers prior to delivering the computers to the purchaser. Thus, for example, an individual may enter a computer store, purchase a computer, take it home, and upon turning on the computer, the individual is presented with an icon on the desktop or other appropriate start mechanism to launch the software of the present invention. This may provide out of-the-box live customer support. This may help ensure proper installation or the sale of additional peripheral items such as printers, scanners, internet subscriptions, and the like. The icon may remain for further customer support if needed or desired.

Note that in this last embodiment it may not be appropriate to require the consumer to play a game, especially when they are seeking customer support. This situation is also within the scope of the present invention. However, the ability to interact personally with a live sales agent has heretofore not been provided for new computer users or those seeking customer support.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. A method of promoting a good or service, comprising:
distributing a computer readable memory device to at least one potential consumer;
checking system parameters on a data processing device into which the computer readable memory device is inserted;
running a promotional game associated with the computer readable memory device on the data processing device;
awarding a promotional prize as a result of the promotional game; and
encouraging the potential consumer to contact a service provider to receive the promotional prize, wherein a sales agent at the service provider may make a sales presentation to the potential consumer prior to collection of the promotional prize.

2. The method of claim 1 wherein checking system parameters comprises checking to determine if a modem is present on the data processing device.

3. The method of claim 1 wherein checking system parameters comprises checking to determine if a sound card is present on the data processing device.

4. The method of claim 1 wherein checking system parameters comprises checking to determine if a video card is present on the data processing device.

5. The method of claim 1 wherein checking system parameters comprises checking to determine if video conferencing software is present on the data processing device.

6. The method of claim 5 wherein checking to determine if video conferencing software is present comprises checking to determine if NetMeeting is present on the data processing device.

7. The method of claim 2 further comprising automatically connecting the potential consumer to the service provider if a modem is detected.

8. The method of claim 1 wherein encouraging the potential consumer to contact a service provider comprises encouraging the potential consumer to contact a sales agent at the service provider via a telephone.

9. The method of claim 1 further comprising soliciting further information from the potential consumer prior to contacting the service provider.

10. The method of claim 1 wherein the service provider provides pornographic services to consumers.

11. The method of claim 1 wherein the service provider provides online trading services to consumers.

12. The method of claim 1 wherein the service provider provides psychic hotline services to consumers.

13. The method of claim 1 wherein the service provider sells home electronics to consumers.

14. The method of claim 13 wherein the service provider sells satellite television dishes and service contracts to consumers.

15. A computer readable medium comprising software adapted to:
check system parameters on a data processing device;
run a promotional game on the data processing device;
award a promotional prize; and
encourage potential consumer to contact a service provider to consummate a sale to collect the promotional prize.

16. A method of promoting a business, comprising:
distributing a computer readable memory device to at least one potential consumer;
determining if a remote communications device is present on a computer into which the computer readable memory device is inserted;
running a promotional game on the computer;
awarding a promotional prize as a result of the promotional game;
connecting the potential consumer to a sales agent at a remote location through the remote communications device if the remote communications device is present so that the potential consumer may claim the promotional prize; and
encouraging the potential consumer to contact a sales agent at a remote location if the remote communications device is not present so that the potential consumer may claim the promotional prize.

17. A method of promoting a good or service comprising:
distributing a software program to at least one potential consumer;
encouraging the at least one potential consumer to run the software program;
allowing the at least one potential consumer to play a game from the software program;
awarding a prize to the at least one potential consumer for playing the game; and
to collect the prize, requiring the at least one potential consumer to contact a sales agent such that the sale agent can make a sales presentation to the at least one potential consumer.

18. A method of purchasing a good or service comprising:
receiving a promotional game;
playing the promotional game to win a prize;
contacting a sales agent at a service provider to collect the prize;
acquiring knowledge about another good or service sold by the service provider; and
purchasing a good or service from the service provider.

19. The method of claim 18 further comprising installing the promotional game on a computer prior to playing the promotional game.

20. The method of claim 18 wherein acquiring knowledge about another good or service sold by the service provider comprises listening to a sales agent over a telephone.

21. The method of claim 18 wherein acquiring knowledge about another good or service sold by the service provider comprises communicating with a sales agent via an online text communication session.

22. The method of claim 18 wherein acquiring knowledge about another good or service sold by the service provider comprises a video conference with a sales agent during which the sales agent pushes content to the purchaser.

23. A system for promoting a good or service, comprising:
a computer readable medium comprising software distributed to at least one potential consumer;
said software adapted to be installed on a computer associated with the at least one potential consumer;
said software adapted to perform a system check on the computer to determine network capabilities, hardware, and software configurations of the computer;
a call center staffed with a plurality of sales agents; and
said software adapted to allow the at least one potential consumer to play a game, be awarded a prize, and encouraged to contact the call center to collect the prize while being subjected to a sales presentation by one of the plurality of sales agents.

24. A method of communicating, comprising:
installing software on a computer prior to delivery to a consumer;
linking the computer to a call center upon activation of the software;
enabling two way communication between a customer support agent and the consumer through the computer.

25. The method of claim 24 further comprising checking, with said software, a system configuration associated with the computer.

26. The method of claim 25 further comprising passing along information derived from checking the system configuration to the customer support agent.

27. The method of claim 24 wherein enabling two way communication between a customer support agent and the consumer comprises selling a good or service to the consumer.

28. The method of claim 24 further comprising, presenting, through said customer support agent, a sales presentation.
